(19) United States
(12) Patent Application Publication
(10) Pub. No.: US 2018/0178537 A1
(43) Pub. Date: Jun. 28, 2018

(54) LIQUID CIRCULATION MODULE, LIQUID DISCHARGING APPARATUS, AND LIQUID DISCHARGING METHOD

(71) Applicant: TOSHIBA TEC KABUSHIKI KAISHA, Tokyo (JP)

(72) Inventors: Hiroshi Murata, Chiyoda Tokyo (JP); Yoshiaki Kaneko, Mishima Shizuoka (JP); Kazuhiko Ohtsu, Mishima Shizuoka (JP)

(21) Appl. No.: 15/691,070

(22) Filed: Aug. 30, 2017

(30) Foreign Application Priority Data
Dec. 22, 2016 (JP) 2016-249140

(51) Int. Cl. B41J 2/18; B41J 2/175; B41J 2/14

(52) U.S. Cl. CPC B41J 2/18; B41J 2/17566; B41J 2/14201; B41J 2/17596

(57) ABSTRACT

According to one embodiment, a liquid circulation module includes a circulation path through which a liquid circulates to and from a liquid discharging head, a first tank in the circulation path on a first side of the liquid discharging head, a supply tank for storing liquid outside of the circulation path and connected to the first tank via a supply path, a first pump feeding liquid from the supply tank to the first tank, and a controller connected to the first pump and configured to control the first pump to feed liquid from the supply tank to the first tank according to a first driving condition and then, subsequently, to control the first pump to feed liquid from the supply tank to the first tank according to a second driving condition. The second driving condition is different from the first driving condition.

### CROSS-REFERENCE TO RELATED APPLICATION

This application is based upon and claims the benefit of priority from Japanese Patent Application No. 2016-249140, filed Dec. 22, 2016, the entire contents of which are incorporated herein by reference.

### FIELD

Embodiments described herein relate generally to a liquid circulation module, a liquid discharging apparatus, and a liquid discharging method.

### BACKGROUND

In an existing liquid discharging apparatus, a liquid discharging head discharges liquid, a liquid tank stores liquid to be supplied to the head, and a circulating type liquid circulation module circulates liquid through a circulation path passing through the liquid discharging head and the liquid tank. In the circulating type liquid circulation module, a supply pump supplies ink from a cartridge to the apparatus and a circulation pump circulates liquid in the circulation path including the liquid discharging head and the liquid tank. As the supply pump or the circulation pump, a diaphragm type piezoelectric pump on a piezoelectric vibration plate is used, for example. However, it is difficult to pump ink into the liquid tank by the supply pump when the liquid tank is empty, and thus it is difficult to provide reliable liquid discharging ability.

### BRIEF DESCRIPTION OF THE DRAWINGS

FIG. 1 is a side view of an ink jet recording apparatus according to an embodiment.

FIG. 2 is a plan view of an inkjet recording apparatus.

FIG. 3 is a perspective view of a liquid circulation module in an ink jet recording apparatus.

FIG. 4 is a perspective view of a liquid circulation module.

FIG. 5 is an explanation view of a liquid circulation module.

FIG. 6 is a cross-sectional view illustrating a structure of an ink jet head in a liquid circulation module.

FIG. 7 is a cross-sectional view of a piezoelectric pump in the ink jet recording apparatus.

FIG. 8 is an operation of a piezoelectric pump in an ink jet recording apparatus.

FIG. 9 is a block diagram of a control system of an ink jet recording apparatus.

FIG. 10 is a flow chart of a control procedure of an ink jet recording apparatus.

FIGS. 11A, 11B, and 11C are views of an operation of an ink jet recording apparatus.

FIG. 12 is a view of driving conditions of an ink jet recording apparatus.

FIG. 13 is a diagram of driving conditions of an inkjet recording apparatus and self-priming pressures.

FIG. 14 is a graph of amplitude of driving voltage and vibration displacement of an ink jet recording apparatus.

FIG. 15 is a graph of amplitude of driving voltage and the self-priming pressure of the inkjet recording apparatus.

### DETAILED DESCRIPTION

According to one embodiment, a liquid circulation module includes a circulation path through which a liquid circulates to and from a liquid discharging head, a first tank in the circulation path on a first side of the liquid discharging head, a supply tank for storing liquid outside of the circulation path and connected to the first tank via a supply path, a first pump feeding liquid from the supply tank to the first tank, and a controller connected to the first pump and configured to control the first pump to feed liquid from the supply tank to the first tank according to a first driving condition and then, subsequently, to control the first pump to feed liquid from the supply tank to the first tank according to a second driving condition. The second driving condition is different from the first driving condition.

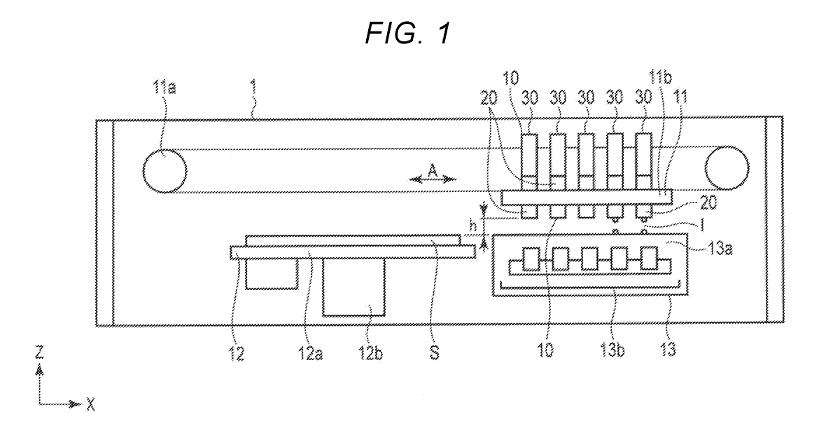

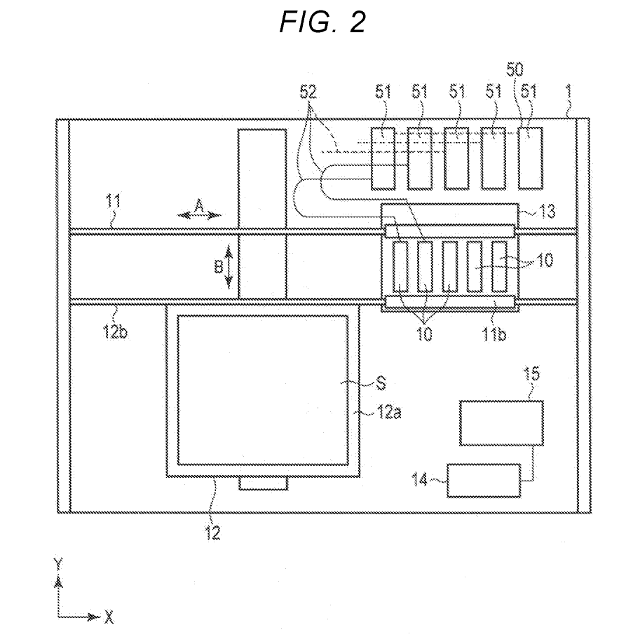

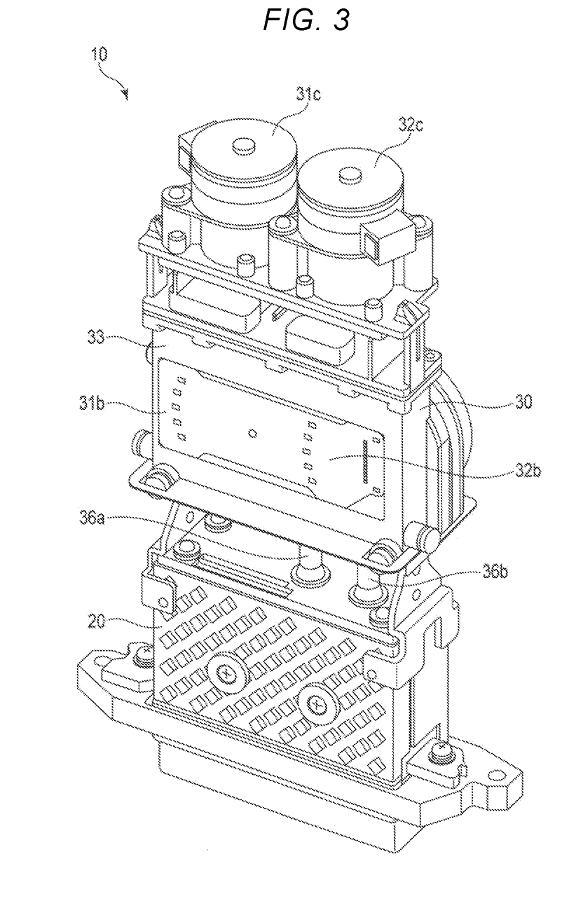

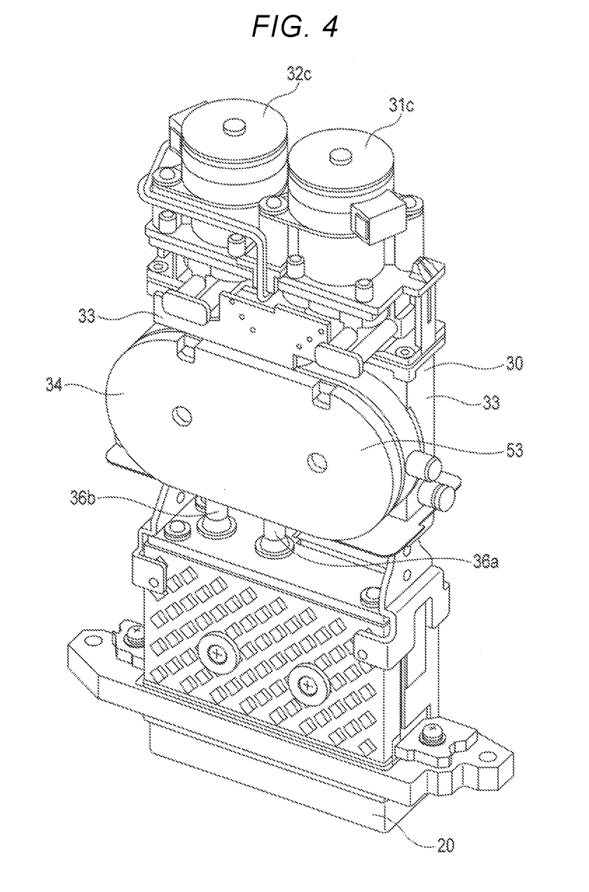

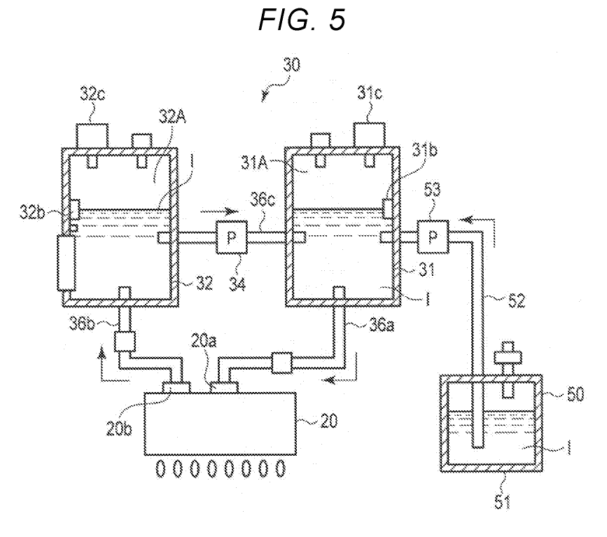

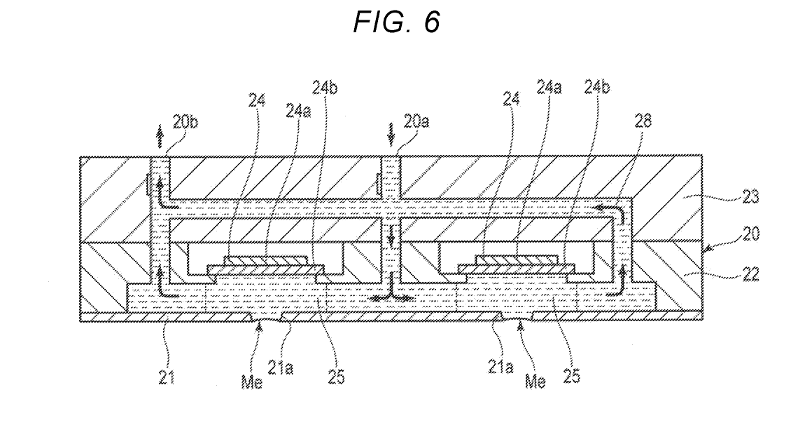

Hereinafter, a liquid circulation module 10 according to an example embodiment and an ink jet recording apparatus 1 which includes the liquid circulation module 10 will be described with reference to FIGS. 1 to 15. In each of the drawings, each component is appropriately enlarged, reduced or omitted for the purpose of explanation. FIG. 1 is a side view of the ink jet recording apparatus 1. FIG. 2 is a plan view of the ink jet recording apparatus 1. FIGS. 3 and 4 are perspective view of the liquid circulation module 10 and FIG. 5 is an explanation view of the liquid circulation module 10.

The ink jet recording apparatus 1 illustrated in FIGS. 1 and 2 includes a plurality of liquid circulation modules 10, a head supporting mechanism 11 which supports the liquid circulation modules 10 such that the liquid circulation modules 10 can move, a medium supporting mechanism 12 that moves and supports a recording medium S, a maintenance unit 13, an interface unit 14, and a controller 15.

The plurality of liquid circulation modules 10 are arranged in parallel with each other in a predetermined direction and are supported by the head supporting mechanism 11. As illustrated in FIGS. 1 to 4, a liquid discharging head 20 and a circulation device 30 are integrated in the liquid circulation modules 10. Each of the liquid circulation modules 10 discharges liquid, for example, ink I, via the liquid discharging head 20, onto the recording medium S facing the liquid circulation modules 10, and forms a desired image the recording medium S.

The plurality of liquid circulation modules 10 discharge ink of a plurality of colors such as cyan ink, magenta ink, yellow ink, black ink, and white ink and the color or characteristics of the ink I to be used are not limited. For example, transparent glossy ink, special ink that is developed when being irradiated with infrared rays or ultraviolet rays, or the like can be discharged instead of white ink. The plurality of liquid circulation modules 10 have the same configuration and may use different ink.

As illustrated in FIGS. 3 to 6, the liquid discharging head 20 is an ink jet head and the liquid discharging head 20 includes a nozzle plate 21, a substrate 22, and a manifold 23 which is bonded to the substrate 22.

The nozzle plate 21 is configured to have a rectangular shape. The nozzle plate 21 includes a plurality of nozzle holes 21a.

The substrate 22 is configured to have a rectangular shape and is bonded to the nozzle plate 21 such that the substrate 22 faces the nozzle plate 21. A predetermined ink flow path 28 which includes a plurality of pressure chambers 25 is formed between the substrate 22 and the nozzle plate 21. The substrate 22 includes a partition portion that separates the pressure chambers 25, which are adjacent in a circumferential direction, from each other. On a portion of the substrate 22 which faces each pressure chamber 25, an actuator 24 is provided.

The actuator 24 is configured into a unimorph type piezoelectric vibration plate which is obtained by stacking a piezoelectric element 24a and a vibration plate 24b. The piezoelectric element is formed of, for example, piezoelectric ceramic material such as lead zirconate titanate (PZT). The vibration plate is formed of, for example, silicon nitride (SiN). The piezoelectric element 24a includes electrodes on the upper and lower portions thereof.

The manifold 23 is configured to have a rectangular shape and is bonded to an upper portion of the substrate 22. The manifold 23 includes a supply port 20a and a collection port 20b through which the manifold 23 communicates with the circulation device 30 and the manifold 23 is configured to have such a shape that the predetermined ink flow path 28 is formed.

In the liquid discharging head 20, the nozzle plate 21, the substrate 22, and the manifold 23 are assembled, also, the plurality of pressure chambers 25, which are separated from one another by a partition wall, are formed. Further, the ink flow path 28 which communicates with each pressure chamber 25 is formed.

As illustrated in FIGS. 1 to 5, the circulation device 30 is connected to an upper portion of the liquid discharging head 20 via a metal connecting component, for example. The circulation device 30 includes an ink casing 33 that includes a supply chamber 31 and a collection chamber 32, a circulation pump 34, a circulation path (including portions 36a, 36b, and 36c), and a supply unit 50.

The ink casing 33 is disposed above the liquid discharging head 20 and includes the supply chamber 31, also referred to as a first tank, and the collection chamber 32, also referred to as a second tank.

The supply chamber 31 is configured to be capable of accommodating liquid and is connected to the upstream side of the liquid discharging head 20. The supply chamber 31 is provided with a liquid level sensor 31b which detects the liquid level in the supply chamber 31. The supply chamber 31 communicates with the liquid discharging head 20 via a supply flow path 36a. In addition, the supply chamber 31 is connected to a cartridge 51 via a supply path 52. The supply chamber 31 is connected to the collection chamber 32 via a connection flow path 36c. The supply chamber 31 is provided with a pressure adjustment device 31c which adjusts the pressure in an air chamber. The pressure adjustment device 31c is disposed on an upper portion of the ink casing 33, for example.

The collection chamber 32 is configured to be capable of accommodating liquid and is connected to the downstream side of the liquid discharging head 20. The collection chamber 32 is provided with a liquid level sensor 32b which detects the liquid level in the collection chamber 32. The collection chamber 32 communicates with the liquid discharging head 20 via a collection flow path 36b. The collection chamber 32 is provided with a pressure adjustment device 32c which adjusts the pressure in an air chamber. The pressure adjustment device 32c is disposed on an upper portion of the ink casing 33, for example.

A supply pump 53 and the circulation pump 34 are provided on the outer surface of the ink casing 33.

The ink casing 33 is provided with a pressure sensor 33a which is a pressure detecting unit that detects the pressure in an air chamber communicating with the supply chamber 31 and the collection chamber 32. The ink casing 33 is connected to the liquid discharging head 20 via the supply flow path 36a and the collection flow path 36b.

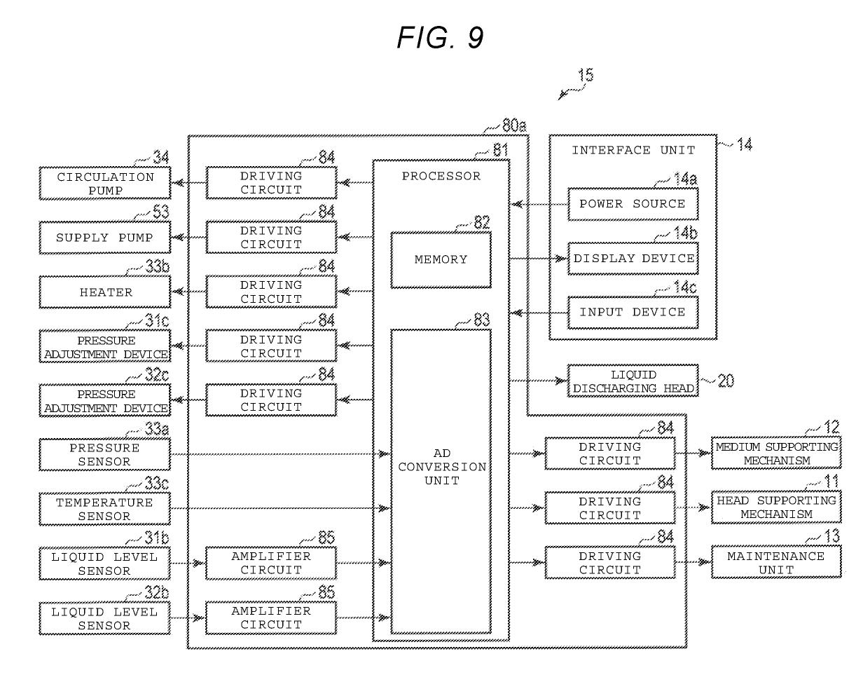

The ink casing 33 is provided with a heater 33b (see FIG. 9) which heats ink. A temperature sensor 33c (see FIG. 9) is attached to the vicinity of the heater 33b of the ink casing 33. The temperature sensor 33c and the heater 33b are connected to the controller 15 and heater 33b is controlled such that a desired ink viscosity is achieved at the time of printing.

The pressure sensor 33a outputs a pressure as an electric signal by using, for example, a semiconductor piezoresistance pressure sensor. The semiconductor piezoresistance pressure sensor includes a diaphragm that receives an external pressure and a semiconductor strain gauge formed on a surface of the diaphragm. The semiconductor piezoresistance pressure sensor detects a pressure by converting the change in electric resistance, which is caused by a piezo resistance effect in the strain gauge accompanying the deformation of the diaphragm that occurs due to an external pressure, into an electric signal. The pressure sensor 33a transmits the detection data to the controller 15.

The circulation path includes the supply flow path 36a, the collection flow path 36b, and the connection flow path 36c. The circulation path extends from the supply chamber 31 to the supply port 20a via the supply flow path 36a and extends from the collection port 20b to the supply chamber 31 through the collection flow path 36b, the collection chamber 32, and the connection flow path 36c.

The supply flow path 36a is a flow path that extends from the supply chamber 31 to the supply port 20a.

The collection flow path 36b is a flow path that extends from the collection port 20b to the collection chamber 32 and the connection flow path 36c is a flow path through which liquid returns from the collection chamber 32 to the supply chamber 31. The connection flow path 36c is provided with the circulation pump 34.

Each of the supply flow path 36a, the collection flow path 36b, and the connection flow path 36c includes a pipe formed of metal or resin material and a tube covering the outer surface of the pipe, for example, a PTFE tube.

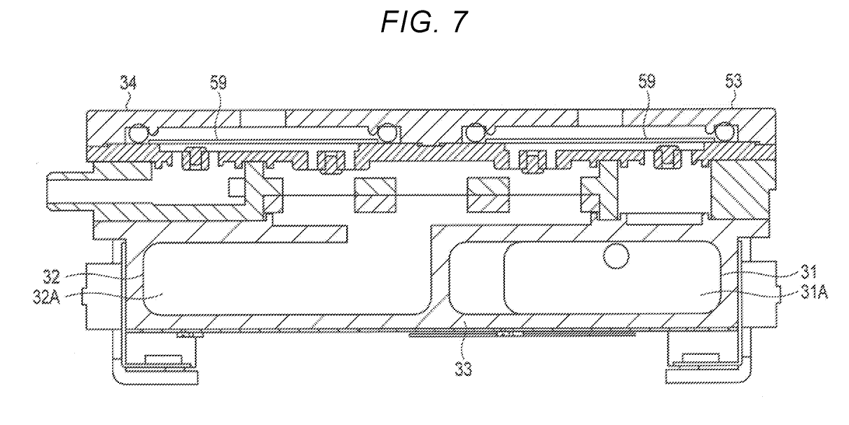

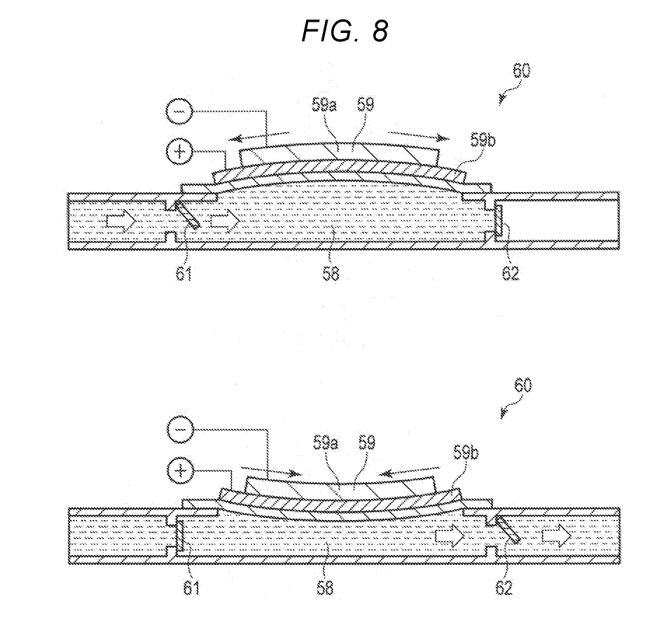

Each of the circulation pump 34 and the supply pump 53 includes, for example, a piezoelectric pump 60. The piezoelectric pump 60 is connected to a driving circuit via a wire and is configured to be capable of being controlled by the controller 15. As illustrated in FIGS. 7 and 8, the piezoelectric pump 60 includes a pump chamber 58, a piezoelectric actuator 59, and check valves 61 and 62 which are disposed at the inlet and the outlet of the pump chamber 58.

The piezoelectric actuator 59 is a piezoelectric vibration plate, which vibrates when a voltage is applied thereto, and can be obtained by sticking a piezoelectric element 59a to a metal (conductive) plate 59b. The piezoelectric actuator 59 is configured to be capable of vibrating at a frequency of approximately 50 Hz to 200 Hz.

When AC voltage is applied to the piezoelectric actuator 59 of the piezoelectric pump 60 and the piezoelectric actuator 59 is operated, the volume of the pump chamber 58 changes. When there is a change in the level of applied voltage, the maximum displacement amount of the piezoelectric actuator 59 of the piezoelectric pump 60 changes and the amount of volume change in the pump chamber 58 changes. When the piezoelectric actuator 59 is deformed so as to increase the volume of the pump chamber 58, the check valve 61 at the inlet of the pump chamber 58 opens so that ink flows into the pump chamber 58. When the piezoelectric actuator 59 is deformed so as to decrease the volume of the pump chamber 58, the check valve 62 at the outlet of the pump chamber 58 opens so that ink flows out from the pump chamber 58. The piezoelectric pump 60 feeds the ink I to the downstream side through repetitive expansions and contractions of the pump chamber 58. Accordingly, if a voltage applied to the piezoelectric actuator 59 is increased, the liquid feeding capacity becomes greater and if the voltage is decreased, the liquid feeding capacity becomes smaller. For example, in the present embodiment, the voltage applied to the piezoelectric actuator 59 changes between 50 V to 150 V.

The circulation pump 34 is provided between the collection chamber 32 on the collection side and the supply chamber 31 on the supply side. The circulation pump 34 feeds liquid in the circulation path to the downstream side.

The supply unit 50 includes the cartridge 51, which is a supply tank provided on the outside of the circulation path, the supply path 52, and the supply pump 53. The cartridge 51 is configured to be capable of retaining ink to be supplied to the supply chamber 31 and an air chamber in the cartridge 51 is open to the atmosphere. The supply path 52 is a flow path that connects the supply chamber 31 and the cartridge 51. The supply pump 53 is provided in the supply path 52 and feeds ink in the cartridge 51 to the supply chamber 31. The supply pump 53 is provided in the supply path 52. The supply pump 53 feeds the ink I retained in the cartridge 51 toward the supply chamber 31.

The head supporting mechanism 11 illustrated in FIG. 1 includes a carriage 11a, a transportation belt 11b, and a carriage motor. The head supporting mechanism 11 is an example of a moving device. When the carriage motor is driven by the controller 15, the transportation belt 11b is caused to travel so that the liquid discharging head 20 supported by the carriage 11a is moved. That is, the head supporting mechanism 11 relatively moves the recording medium S with respect to the liquid circulation module 10.

The medium supporting mechanism 12 includes a supporting table 12a and a slide rail 12b. The medium supporting mechanism 12 is an example of a moving device that relatively moves the recording medium S with respect to the liquid circulation module and moves the supporting table 12a along the slide rail 12b while being controlled by the controller 15.

The maintenance unit 13 is disposed at a stand-by position outside of a moving range of the supporting table 12a. The maintenance unit 13 includes a removing blade 13a which is formed of rubber and a waste ink unit 13b that includes an opening on the upper portion thereof. The maintenance unit 13 rises at a predetermined time, wipes a surface of the nozzle plate 21 with the removing blade 13a, and covers the nozzle plate 21 with the waste ink unit 13b so as to prevent evaporation of ink and adhesion of dust or paper dust to the nozzle plate 21. This process is referred to as a capping function.

The interface unit 14 includes a power source 14a, a display device 14b, and an input device 14c (see FIG. 9). The interface unit 14 is connected to the controller 15. A user operates the input device 14c of the interface unit 14 to instruct the controller 15 to perform various operations. The interface unit 14 displays various information or an image on the display device 14b while being controlled by the controller 15.

FIG. 9 is a block diagram of the controller 15 which controls the operation of the ink jet recording apparatus 1. The controller 15 includes a control board 80a, a processor 81 which is placed on the control board 80a and controls the operation of each unit, a memory 82 which stores a program or various data, an AD conversion unit 83 which converts analog data (voltage value) into digital data (bit data), a driving circuit 84 which drives each component, and an amplifier circuit 85.

The control board 80a is configured to have a rectangular shape, for example, and is disposed on a side surface of the circulation device 30 above the liquid discharging head 20.

The processor 81 includes a central processing unit (CPU) and corresponds to the central unit of the controller 15. The processor 81 controls each unit in the ink jet recording apparatus 1 such that various functions of the ink jet recording apparatus 1 are realized according to an operating system or an application program.

The processor 81 is connected to the interface unit 14 which includes the power source 14a, the display device 14b, the input device 14c, and the like. The processor 81 is connected to a driving unit of the various pumps or the various sensors and controls the operation of the ink jet recording apparatus 1. The processor 81 captures information detected by the pressure sensor 33a or the liquid level sensors 31a and 32b by using the AD conversion unit 83.

When a control process is executed by the processor 81 based on a control program, which is recorded in the memory 82 in advance, the controller 15 functions as a circulation unit and a supply unit. For example, the processor 81 has a function as a circulation unit which is a function of circulating ink by controlling the operation of the circulation pump 34. The processor 81 has a function as a supply unit which is a function of supplying ink from the cartridge 51 to the circulation path by controlling the operation of the supply pump 53 based on information detected by the liquid level sensors 31b and 32a. In addition, the processor 81 has a function as a pressure adjustment unit which is a function of adjusting the pressure by controlling the operation of the pressure adjustment devices 31c and 32c based on pressure data detected by the pressure sensor 33a.

The memory 82 is, for example, a non-volatile memory and the memory 82 is mounted on the controller 15. In the memory 82, various control programs and operation conditions are stored as information required for control of an ink circulation operation, control of an ink supply operation, pressure adjustment, temperature management, and ink surface management.

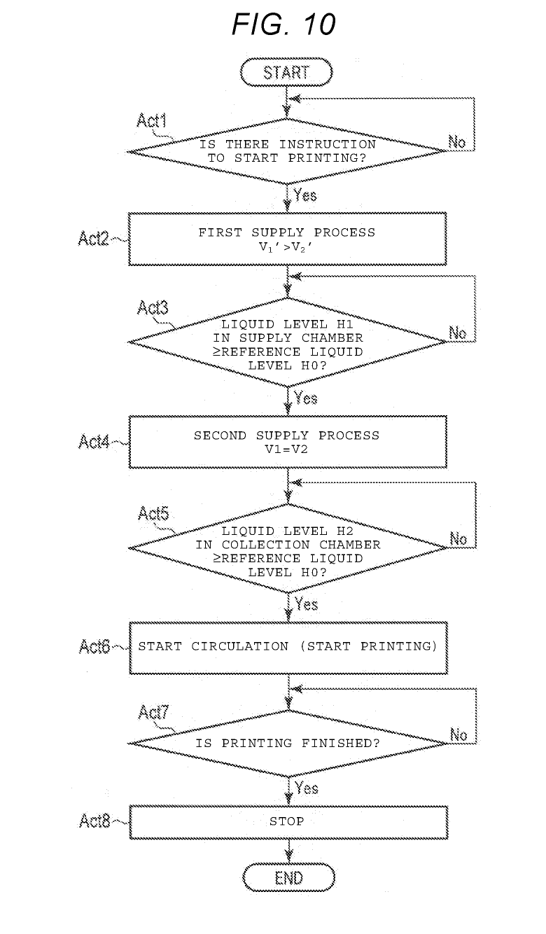

Hereinafter, a flow chart of a liquid discharging operation in the ink jet recording apparatus 1 will be described. FIG. 10 is a flow chart of a control procedure of the ink jet recording apparatus 1. A liquid discharging method includes a first supply process of driving the supply pump 53 which feeds liquid from the cartridge 51 to the supply chamber 31 under a first driving condition and a second supply process of driving the supply pump 53 under a second driving condition after the first supply process.

For example, when an instruction to start printing is detected with an input operation with respect to the interface unit 14 (Act 1), the processor 81 starts the first supply process as an initial filling process in which the supply pump 53 without liquid therein pumps liquid into the supply chamber 31 (Act 2).

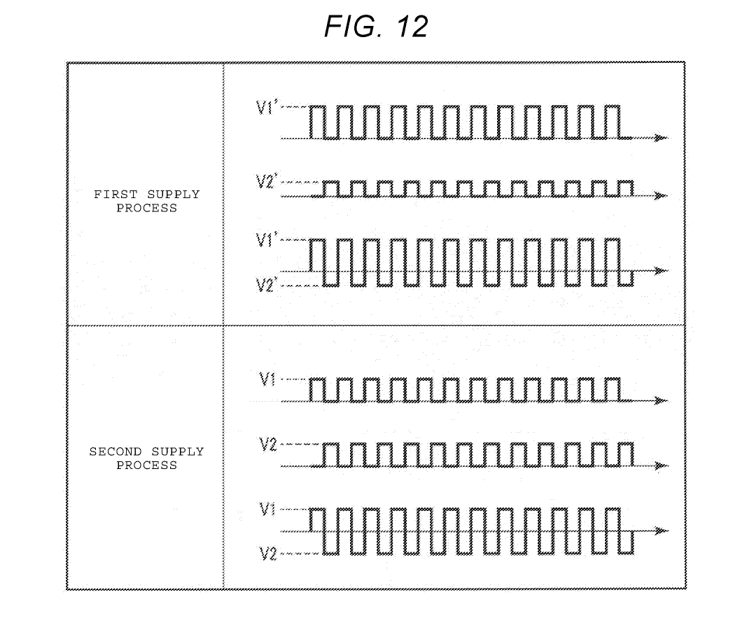

As the first supply process, the processor 81 drives the supply pump 53 with a first drive waveform illustrated in FIG. 12 so that liquid is fed from the cartridge 51 to the supply chamber 31.

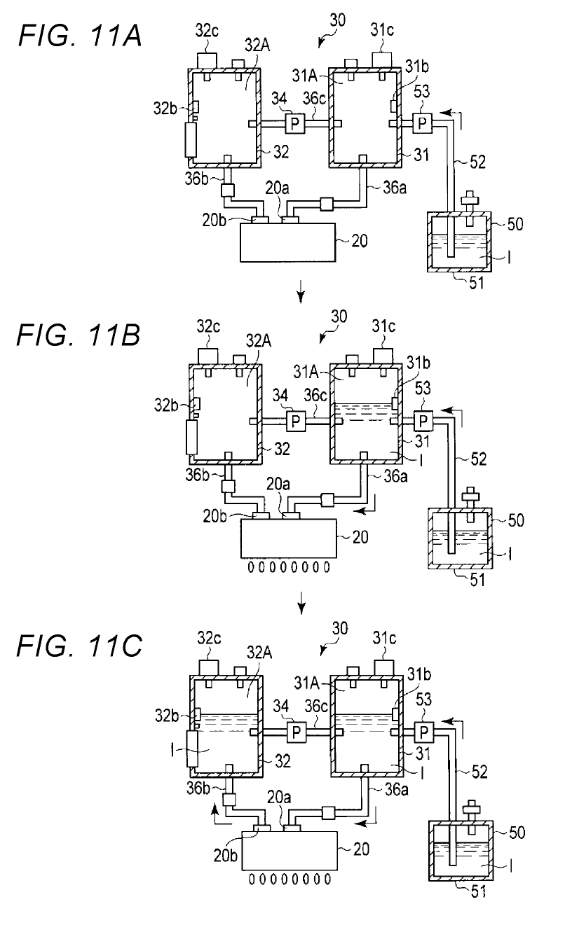

FIGS. 11A to 11C are views of an initial state (FIG. 11A) of the ink jet recording apparatus 1, a state at the time of a filling operation (FIG. 11B), and a state at the time of circulation (FIG. 11C), respectively. As illustrated in FIGS. 11A to 11C, in the initial state (FIG. 11A) in which the supply chamber 31 is empty and the circulation path is not filled with liquid, the first supply process is started using the first drive waveform.

FIG. 12 is a view of a first drive waveform in the first supply process and a second drive waveform in the second supply process. Here, a voltage applied to the piezoelectric element 59a (PZT) side is denoted by V1′ and V1 and a voltage applied to the metal plate 59b side is denoted by V2′ and V2, in the first drive waveform and the second drive waveform, respectively. A synthesized waveform is illustrated in the lower portion in the first drive form and the second drive form. As illustrated in FIG. 12, V1′>V2′ is satisfied in the first drive waveform and V1=V2 is satisfied in the second drive waveform. That is, in the first drive waveform, a positive electric field (V1′ side) is greater than a negative electric field (V2′ side) and the electric fields are offset from each other. In this case, even if there is no change in voltage amplitude, vibration of the piezoelectric vibration plate is likely to cause contraction and the piezoelectric vibration plate vibrates so as to decrease the inner volume of a pump. At the time of an initial filling operation in which the supply pump 53 without liquid therein pumps liquid into the supply chamber 31, a high voltage V1′ is applied to the piezoelectric element (PZT) side and a low voltage V2′ is applied to the metal plate side.

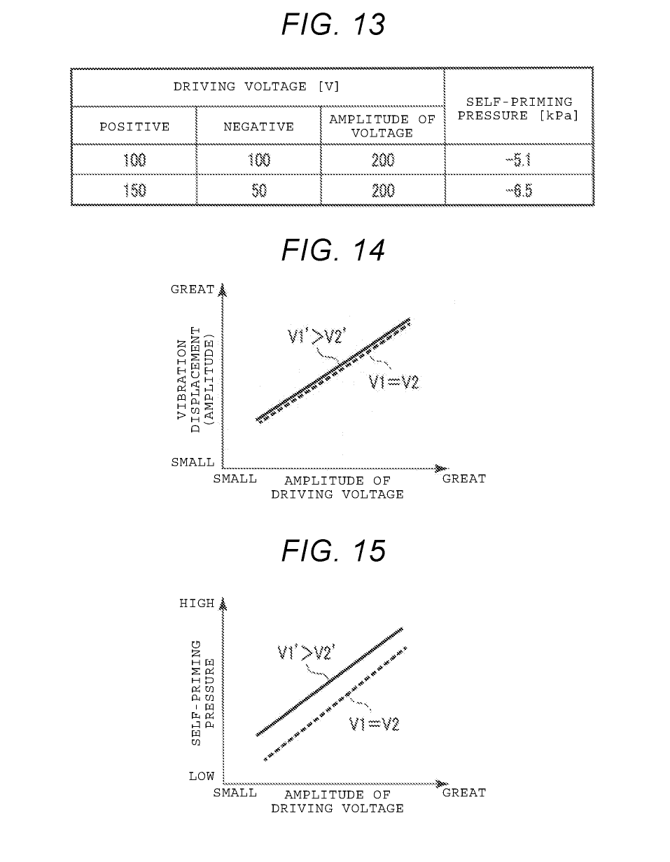

As illustrated in FIG. 13, when the same supply pump 53 is used, the first drive waveform, in which a positive electric field (V1′ side) is greater than a negative electric field (V2′ side) and the electric fields are offset from each other, results in a greater self-priming pressure than the second drive waveform in which a positive electric field (V1 side) is equal to a negative electric field (V2 side). Accordingly, it is possible to secure a higher self-priming pressure in the first supply process than that in the second supply process.

As illustrated in FIG. 11B, when the first supply process is continued for a predetermined time, liquid is pumped by the supply pump 53 into to the supply chamber 31, and the liquid level in the supply chamber 31 increases.

The processor 81 determines whether or not the liquid level H1 in the supply chamber 31 reaches a predetermined reference value H0 based on detection data from the liquid level sensor 31b (Act 3). When the liquid level in the supply chamber 31 does not reach the predetermined reference value (No in Act 3), the processor 81 continues the first supply process. That is, the processor 81 continues the first supply process while a condition for the initial filling operation is satisfied. Here, an example of the condition for the initial filling operation is that the liquid level H1 in the supply chamber 31 is below the reference value H0.

When the liquid level in the supply chamber 31 reaches the predetermined reference value H0, (Yes in Act 3), the processor 81 starts the second supply process using the second drive waveform illustrated in FIG. 12 (Act 4). That is, if it is detected that a condition for switching from the first supply process to the second supply process is satisfied, the processor 81 starts the second supply process. In the second drive waveform, a positive voltage V1 and a negative voltage V2 are equal to each other and there is no offset.

As illustrated in FIG. 11C, as a result of the second supply process, the circulation path including the liquid discharging head 20 is filled with liquid and the liquid level in the collection chamber 32 increases.

The processor 81 determines whether or not the liquid level H2 in the collection chamber 32 reaches the predetermined reference value H0 based on detection data from the liquid level sensor 32b (Act 5) and continues the second supply process until the liquid level in the collection chamber 32 reaches the predetermined reference value (No in Act 5).

When the liquid level H2 in the collection chamber 32 reaches the predetermined reference value H0, the processor 81 determines that a filling process is finished and starts a printing process (Act 6).

In the printing process in Act 6, the liquid circulation module 10 reciprocates in a direction orthogonal to a transportation direction of the recording medium S and the liquid discharging head 20 performs an ink discharging operation so that an image is formed on the recording medium S.

Specifically, the processor 81 transports the carriage 11a, with which the head supporting mechanism 11 is provided, in a direction of the recording medium S and reciprocates in the arrow A direction. The processor 81 of the controller 15 selectively drives the actuator 24 of the liquid discharging head 20 by transmitting an image signal according to the image data to the driving circuit 84 of the liquid discharging head 20 so that ink droplets are discharged onto the recording medium S from the nozzle hole 21a.

In the printing process, the processor 81 drives the circulation pump 34 to start the ink circulation operation. The ink I circulates such that the ink I flows out from the supply chamber 31, reaches the liquid discharging head 20, and flows into the supply chamber 31 again through the collection chamber 32. Through the circulation operation, impurities in the ink I are removed by a filter provided in the circulation path.

In the printing process, the processor 81 performs a supply process by driving the supply pump 53 by using the second drive waveform at a predetermined time. Specifically, the processor 81 performs a supply operation with ink from the cartridge 51 by driving the supply pump 53 by using the second drive waveform based on the result of the detecting operation of the liquid level sensors 31b and 32a so as to adjust the position of the liquid surface such that the position falls within an appropriate range. For example, the ink supply is performed when ink droplets ID are discharged from the nozzle hole 21a during printing so that the amount of ink in the supply chamber 31 is momentarily decreased and the liquid surface is lowered. If the amount of ink increases again and the output of the liquid level sensor 31b is inverted, the processor 81 stops the supply pump 53.

In the printing process, the processor 81 detects the pressure of ink in a nozzle from the pressure data which is transmitted from the pressure sensor 33a. Specifically, the pressure of ink in the nozzle hole 21a is calculated using a predetermined formula based on the pressure data of the supply chamber 31 and the collection chamber 32 which is transmitted from the pressure sensor 33a.

For example, it is possible to obtain the pressure Pn of ink in a nozzle by adding a pressure ρgh, which is generated due to a difference in the hydraulic head between the height of a liquid surface in the supply chamber 31 and the collection chamber 32 and the height of a nozzle surface, to the average of a pressure value Ph of an air chamber in the supply chamber 31 and a pressure value P1 of an air chamber in the collection chamber 32. Here, “ρ” indicates the density of ink, “g” indicates the gravitational acceleration, and “h” indicates a distance between the liquid surface in the supply chamber 31 and the collection chamber 32 and the nozzle surface in a height direction.

In the printing process, the processor 81 calculates the driving voltage based on the pressure Pn of ink in the nozzle, which is calculated from the pressure data, as a pressure adjustment process. The processor 81 controls the operation of the circulation pump 34 or the pressure adjustment devices 31c and 32c such that the pressure Pn of ink in the nozzle becomes an appropriate value. As a result, a negative pressure is maintained to such an extent that the ink I does not leak from the nozzle hole 21a of the liquid discharging head 20 and air bubbles are not suctioned via the nozzle hole with a meniscus Me being maintained.

According to the liquid circulation module 10 configured as described above, since the supply pump 53 is driven under a driving condition in which driving voltages are offset from each other at the time of the initial filling operation in which liquid is supplied into the supply chamber 31 by the supply pump 53, it is possible to secure a high self-priming pressure.

FIG. 13 shows values of a self-priming pressure at which the supply pump, when including no liquid therein, pumps air in while being driven by the first drive waveform and the second drive waveform. As a result of measurement of the self-priming pressure, it was found that the self-priming pressure when driven by the first drive waveform was greater than that when driven the second drive waveform. Thus, it is desirable that the absolute value of the self-priming pressure is higher than the absolute value of −6 kPa and it is possible to obtain the necessary pressure when driven by the first drive waveform. That is, it is possible for the supply pump 53 without liquid to sufficiently pump in liquid when the supply process is performed under a driving condition in which voltages are offset from each other.

FIG. 14 is a graph illustrating the result of measurement of vibration displacement of the piezoelectric vibration plate installed in the supply pump 53, which is performed by using a displacement gauge that uses laser light. FIG. 14 illustrates a comparison between a case where voltages are not offset from each other as in the second drive waveform and a case where voltages are offset from each other as in first drive waveform. The result was obtained by measuring vibration displacement while changing a number of conditions about the amplitude of driving voltage. As illustrated in FIG. 14, vibration displacement depends on the amplitude of driving voltage and does not depend on whether or not voltages are offset from each other.

FIG. 15 illustrates a comparison between the first drive waveform and the second drive waveform in measured self-priming pressure. As illustrated in FIG. 15, the self-priming pressure in the case of the first drive waveform is greater than that in the case of the second drive waveform even if there is no difference in amplitude of driving voltage. The self-priming pressure is increased in this case because vibration resulting in a decrease in volume of a pump becomes great with a high voltage applied to the piezoelectric element and thus the piezoelectric vibration plate vibrates in such a direction that the inner volume of a pump being operated becomes substantially smaller than that of the pump in an stationary state. Since the electric field is applied at least at the time of the initial liquid filling operation, it is possible to secure a high self-priming pressure and to obtain a stable liquid discharging ability.

The present disclosure is not limited to the particulars of the above-described example embodiments and various components may be modified without departing from the spirit of the present disclosure.

For example, in the above-described embodiments, the condition for the initial filling operation, which is a condition for performing the first supply process, is set based on the liquid level of the supply chamber 31. However, the disclosure is not limited to this condition. For example, the liquid level in both of the supply chamber 31 and the collection chamber 32, or the liquid level only in the collection chamber 32 may be detected and the condition for the initial filling operation may be set based on the detected liquid level. Further, instead of control based on the detected liquid level, the first supply process may be performed during a predetermined reference time as a condition for the initial filling operation and then first supply process may be switched to the second supply process after the predetermined reference time elapses so that afterwards the second supply process is performed.

In addition, the driving condition is not limited to those described above and, for example, in a case where driving voltages are offset from each other, a voltage may be applied so as to increase the polarization of a piezoelectric body (PZT).

Similarly, a configuration of the liquid circulation module 10 is also not limited to that in the above-described examples.

In addition, liquid to be discharged is not limited to ink and, in general, any liquid may be discharged. Examples of a liquid discharging apparatus that discharges liquid other than ink may include a device that discharges liquid containing conductive particles for forming a wiring pattern of a printed circuit board.

In addition to the above described configuration, the liquid discharging head 20 may have a configuration in which ink droplets are discharged with a vibration plate being deformed due to static electricity or a configuration in which ink droplets are discharged from a nozzle by using thermal energy from a heater or the like.

In the above described embodiment, a liquid discharging apparatus of an ink jet recording apparatus 1 is described. However, the disclosure is not limited to this usage and the liquid discharging apparatus can be used as a part of a 3D printer or an industrial manufacturing machine, for medical purposes, and can vary in assorted ways to be reduced in size, weight, and cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid circulation module, comprising:
a circulation path through which a liquid circulates to and from a liquid discharging head;
a first tank in the circulation path on a first side of the liquid discharging head;
a supply tank for storing liquid outside of the circulation path and connected to the first tank via a supply path;
a first pump feeding liquid from the supply tank to the first tank; and
a controller connected to the first pump and configured to control the first pump to feed liquid from the supply tank to the first tank according to a first driving condition and then, subsequently, to control the first pump to feed liquid from the supply tank to the first tank according to a second driving condition, wherein
the second driving condition is different from the first driving condition.

2. The liquid circulation module according to claim 1, wherein
the first pump is a piezoelectric pump comprising a pump chamber and a piezoelectric actuator, the piezoelectric actuator having a first electrode and a second electrode,
the controller controls a driving circuit in the first driving condition to apply a first voltage on the first electrode and a second voltage on the second electrode, the first voltage being different from the second voltage such that vibration displacement in a direction in which the pump chamber is contracted is greater than vibration displacement in a direction in which the pump chamber is expanded,
and
the controller controls the driving circuit in the second driving condition to apply a third voltage on the first electrode and a fourth voltage on the second electrode, the third voltage being equal to the fourth voltage.

3. The liquid circulation module according to claim 2, further comprising:
a first sensor configured to detect an amount of liquid in the first tank, wherein
the controller controls the first pump according to the first driving condition when the detected amount of liquid is below a first predetermined amount, and
the controller controls the first pump according to the second driving condition when the detected amount of liquid in the first tank is at or above the first predetermined amount.

4. The liquid circulation module according to claim 2, wherein
the controller controls the first pump according to the first driving condition until a predetermined reference time has elapsed from a start of feeding liquid from the supply tank to the first tank, and
the controller controls the first pump according to the second driving condition after the predetermined reference time has elapsed from the start of feeding.

5. The liquid circulation module according to claim 3, further comprising:
a second tank in the circulation path on a second side of the liquid discharging head; and
a second pump in the circulation path between the first tank and the second tank.

6. The liquid circulation module according to claim 5, further comprising:
a second sensor configured to detect an amount of liquid in the second tank, wherein
the controller controls the first pump according to the first driving condition when at least one of the detected amount of liquid in the first tank and the detected amount of liquid in the second tank is below the first predetermined amount and a second predetermined amount, respectively, and
the controller controls the first pump according to the second driving condition when both the detected amount of liquid in the first tank and the detected amount of liquid in the second tank are at or above the first predetermined amount and the second predetermined amount, respectively.

7. The liquid circulation module according to claim 5, wherein the second pump is a piezoelectric pump.

8. The liquid circulation module according to claim 1, wherein the supply tank is a cartridge and is open to atmosphere.

9. A liquid discharging apparatus, comprising:
a liquid discharging head;
a circulation path through which a liquid circulates to and from the liquid discharging head;
a first tank in the circulation path on a first side of the liquid discharging head;
a supply tank for storing liquid outside of the circulation path and connected to the first tank via a supply path;
a first pump feeding liquid from the supply tank to the first tank;
a controller connected to the first pump and configured to control the first pump to feed liquid from the supply tank to the first tank according to a first driving condition and then, subsequently, to control the first pump to feed liquid from the supply tank to the first tank according to a second driving condition; and
a moving device that moves a recording medium, on which an image is formed, with respect to the liquid discharging head, wherein
the second driving condition is different from the first driving condition.

10. The liquid discharging apparatus according to claim 9, wherein
the first pump is a piezoelectric pump comprising a pump chamber and a piezoelectric actuator, the piezoelectric actuator having a first electrode and a second electrode,
the controller controls a driving circuit in the first driving condition to apply a first voltage on the first electrode and a second voltage on the second electrode, the first voltage being different from the second voltage such that vibration displacement in a direction in which the pump chamber is contracted is greater than vibration displacement in a direction in which the pump chamber is expanded, and
the controller controls the driving circuit in the second driving condition to apply a third voltage on the first electrode and a fourth voltage on the second electrode, the third voltage being equal to the fourth voltage.

11. The liquid discharging apparatus according to claim 10, further comprising:
a first sensor configured to detect an amount of liquid in the first tank, wherein
the controller controls the first pump according to the first driving condition when the detected amount of liquid is below a first predetermined amount, and
the controller controls the first pump according to the second driving condition when the detected amount of liquid in the first tank is at or above the first predetermined amount.

12. The liquid discharging apparatus according to claim 10, wherein
the controller controls the first pump according to the first driving condition until a predetermined reference time has elapsed from a start of feeding liquid from the supply tank to the first tank, and
the controller controls the first pump according to the second driving condition after the predetermined reference time has elapsed from the start of feeding.

13. The liquid discharging apparatus according to claim 11, further comprising:
a second tank in the circulation path on a second side of the liquid discharging head; and
a second pump in the circulation path between the first tank and the second tank.

14. The liquid discharging apparatus according to claim 13, further comprising:
a second sensor configured to detect an amount of liquid in the second tank, wherein
the controller controls the first pump according to the first driving condition when at least one of the detected amount of liquid in the first tank and the detected amount of liquid in the second tank is below the first predetermined amount and a second predetermined amount, respectively, and
the controller controls the first pump according to the second driving condition when both the detected amount of liquid in the first tank and the detected amount of liquid in the second tank are at or above the first predetermined amount and the second predetermined amount, respectively.

15. The liquid discharging apparatus according to claim 13, wherein the second pump is a piezoelectric pump.

16. The liquid discharging apparatus according to claim 9, wherein the supply tank is a cartridge and is open to atmosphere.

17. A liquid discharging method, comprising:
controlling a first pump to feed a liquid from a supply tank to a first tank, according to a first driving condition; and
controlling a first pump to feed the liquid from the supply tank to the first tank according to a second driving condition, wherein
the liquid circulates to and from a liquid discharging head through a circulation path,
the first tank is disposed in the circulation path on a first side of the liquid discharging head,
the supply tank is disposed outside of the circulation path and connected to the first tank via a supply path, and
the first pump is disposed in the circulation path between the first tank and the liquid discharging head.

18. The liquid discharging method according to claim 17, wherein
the first pump is a piezoelectric pump comprising a pump chamber and a piezoelectric actuator, the piezoelectric actuator having a first electrode and a second electrode,
the controller controls a driving circuit in the first driving condition to apply a first voltage on the first electrode and a second voltage on the second electrode, the first voltage being different from the second voltage such that vibration displacement in a direction in which the pump chamber is contracted is greater than vibration displacement in a direction in which the pump chamber is expanded, and
the controller controls the driving circuit in the second driving condition to apply a third voltage on the first electrode and a fourth voltage on the second electrode, the third voltage being equal to the fourth voltage.

19. The liquid discharging method according to claim 18, further comprising:
detecting an amount of the liquid in the first tank; and
controlling the first pump according to the first condition or the second condition according to based on the detected amount of the liquid in the first tank.

20. The liquid discharging method according to claim 17, further comprising:
controlling the first pump according to the first condition or the second condition based on an elapse of time after a start of feeding the liquid from the supply tank to the first tank.
